(19) United States
(12) Patent Application Publication
(10) Pub. No.: US 2014/0351129 A1
(43) Pub. Date: Nov. 27, 2014

(54) CENTRALIZED VERSATILE TRANSACTION VERIFICATION

(71) Applicant: Hewlett-Packard Development Company, L.P., Houston, TX (US)

(72) Inventors: Audrey S. Finot, Palo Alto, CA (US); Antoine Voiry, Les Ulis (FR); Warren Gerard Burrell, Alpharetta, GA (US); Angela M. Narvaez, Houston, TX (US); Reeves I. Washington, Alpharetta, GA (US); Don Clickner, Cameron Park, CA (US)

(73) Assignee: Hewlett-Packard Development Company, L.P., Houston, TX (US)

(21) Appl. No.: 13/902,401

(22) Filed: May 24, 2013

(51) Int. Cl. G06Q 20/40

(52) U.S. Cl. CPC G06Q 20/401
USPC 705/44

(57) ABSTRACT

Example embodiments relate to centralized transaction verification. In example embodiments, a system may maintain a set of tracked attributes and a set of conditions, each condition to provide an indication of whether generally a transaction should be allowed based on at least one of the tracked attributes and an associated value. The system may receive transaction data packets from multiple heterogeneous transaction placement systems, each transaction data packet to relate to a particular transaction and to include any number attributes of any type and any formatting. The system may normalize each of the transaction data packets. The system may verify each of the transaction data packets by analyzing a subset of conditions where the conditions in the subset are related to the attributes associated with the particular transaction data packet.

### BACKGROUND

Entities (e.g., companies) that produce products and/or offer services may have to deal with the reality that various bad actors may attempt to perform various actions that may be harmful to the entity. For example, bad actors may attempt to offer counterfeits or frauds of products and/or services offered by the entity. Other examples of harmful actions include attempts to steal products and/or services, for example, by providing fraudulent information. When these attempted actions are successful, they may be harmful to the entity in a variety of ways, for example: they may introduce risk into the supply chain of the entity; they may impact customer satisfaction with the entity's products and/or services (e.g., if inferior counterfeit products/services reach customers); they may cut into the entity's top-line revenue (e.g., via fraudulent sales and/or discounts); and they may increase bottom-line costs (e.g., via service fraud). All of these actions may hurt the entity and/or the entity's brand (e.g., the reputation of the entity), and thus, may be referred to as “brand attacks”. The term “brand protection” may refer to measures taken (e.g., by such an entity) to prevent such harmful actions.

### BRIEF DESCRIPTION OF THE DRAWINGS

The following detailed description references the drawings, wherein:

FIG. 1 is a block diagram of an example network setup, where a system for centralized versatile transaction verification may be used in such a network setup;

FIG. 2 is a block diagram of an example verification service (VS) for centralized versatile transaction verification according to the present disclosure;

FIG. 3 is a flowchart of an example method for centralized versatile transaction validation, specifically, related to handling non-normalized transaction data;

FIG. 4 is a flowchart of an example method for centralized versatile transaction validation, specifically, related to verifying a transaction and using verification logic;

FIG. 5 is a block diagram of an example verification computing device for centralized versatile transaction validation; and

FIG. 6 is a flowchart of an example method for centralized versatile transaction validation.

### DETAILED DESCRIPTION

As explained above, bad actors may attempt to perform various actions (i.e., “brand attacks”) that may hurt an entity (e.g., a company) and/or the entity's brand. Among the other harms described above, such brand attacks may be very costly for an entity, especially a large entity, e.g., with large networks of providers and the like. For large entities, the cost of brand attacks may be in the tens of millions of dollars annually, for example. Throughout this disclosure, the term “brand attack” or “bad action” may be used to refer to any of the various bad actions that may be committed against an entity (e.g., counterfeiting, theft, fraud, etc.), actions which may harm the reputation/brand of the entity and/or which may cause other types of harm to the entity.

An example approach to brand protection involves investigations conducted (e.g., by agents of the entity) after a bad action has occurred. While such investigations may be useful as part of a brand protection strategy, such investigations may be costly (e.g., requiring significant investment of resources) and may only be successful a fraction of the time. For many bad actions (e.g., those committed on a small scale), an entity may rarely recover the full loss caused by the bad action, for example, because the cost of investigation for these actions may be too high. Thus, it may only be worthwhile for an entity to investigate the most significant (e.g., large-scale) bad actions. It may be desirable for an entity to have a way to deal with smaller scale brand attacks, because even smaller scale attacks, when accumulated over a large number of transactions, can have a significant financial impact on the entity. Additionally, it may be desirable for an entity to have a way to proactively detect bad actions.

Another challenge of brand protection is that these bad actors, unfortunately, may be intelligent, adaptive and persistent in their brand attacks. Therefore, an entity may desire a sophisticated system to help detect and prevent such brand attacks. Some transaction verification systems may exist, for example, to verify stock purchasing transactions (e.g., placed via a bank or broker) or e-commerce transactions (e.g., placed via a merchant computer). These verification systems may be designed to handle a particular type of transaction for a particular type of system. For example, a verification system for stock purchasing transactions may be designed to handle only transactions related to stock purchases, and the verification system may know the precise details of the bank/broker system used to place such stock purchasing transactions. The verification system may even be integrated into the bank/broker system. The verification system also may expect to receive particular pieces of transaction data from the bank/broker system in a particular format, for example, certain types of data (e.g., the stock ticker, transaction date, etc.), entered into certain fields, in a certain way.

If a verification system is used for a particular type of business in association with a particular system, such verification systems described above may be beneficial. However, some entities (e.g., large entities with large numbers of partners, distributors, retailers and the like) may use a wide variety of systems to facilitate a wide variety of transactions. In such a scenario, each of the variety of transaction systems could implement its own specific transaction verification system. However, in such a scenario, each transaction verification system may have to maintain its own knowledge base (e.g., information used to determine whether a transaction should be allowed) and/or its own transaction verification logic. For each of these transaction verification systems, the knowledge base and/or verification logic may be complex, and yet, may be redundant, for example, if knowledge about various risks, actions and the like maintained in one verification system may be relevant to other verification systems.

The present disclosure describes a system for centralized versatile transaction verification. The system may be used to proactively verify transactions, in real time, for a wide variety of systems and a wide variety of transactions. The system may receive transaction data (e.g., from transaction placement systems) in a wide variety of formats. The system may receive and handle pieces of transaction data that are familiar to the system or it may receive and handle pieces of transaction data that are not familiar to the system. The system may maintain a central knowledge base (e.g., regarding various risks, actions and the like) for all the transaction placement systems. The system may maintain central transaction verification logic. The central knowledge base and/or verification logic may be used to flag transactions that may be associated with known or suspected risks and/or risk factors. The system may take advantage of knowledge gained during verification of a first type of transaction while verifying a second type of transaction. Likewise, the system may take advantage of knowledge gained during verification of a transaction from a first transaction system while verifying a transaction from a second transactions system. This versatility may allow the system to verify (e.g., on behalf of a single entity) various types of transactions that take place across multiple organizations, systems, processes applications and the like of an entity. The present disclosure may include an analytics module, which may allow the system to adapt to the evolving techniques of the bad actors.

Throughout this disclosure, the term “transaction verification,” or simply verification, may refer to the process of determining whether a particular transaction (e.g., the sale of a computer or the shipment of a replacement part) should be allowed to complete or whether a particular transaction has complied with various requirements or guidelines. Transaction verification may also be referred to as validation, compliance, compliance verification, compliance validation, or the like. The term “transaction” may refer to any business-related action, for example, between two or more parties, or between one party and an automated transaction system. Such parties may be working for or on behalf an entity, e.g., referred to as first parties. Other parties may be customers or recipients of products and/or services of the entity, e.g., referred to as second parties. It should be understood that the present disclosure is not limited to verification of transactions with regard to detection of bad actors. The present disclosure may be used to verify transactions by referencing conditions, and the conditions may be designed to check for any scenario. For example, a condition may be designed to ensure that customers are receiving high quality services and/or tailored customer support experiences. Various descriptions provided below may use the example of conditions designed to detect bad actions, but it should be understood that those descriptions may be expanded to apply to various other conditions.

The present disclosure may describe a system that may verify transactions of various types; therefore, providing a few examples of various transactions may be useful. In one example scenario, a third party (e.g., a purchaser of a business server from an entity) may call the entity's customer support to report a problem with a product (e.g., the business server). The third party may reach a customer support agent and may explain that the third party believes it should receive a replacement part for the product (e.g., a new hard drive). The agent may then determine whether the third party should receive such a replacement part (e.g., depending on warranty information), and may submit an order to purchase and ship (e.g., via at least one transaction placement system) the replacement part. In such a situation, the third party may be a bad actor, and, for example, may provide fraudulent information in order to receive a free replacement part. As another example, the customer support agent may be a fraudulent actor, and, for example, may charge the customer for the hard drive and pocket the money received. In this situation, the system(s) used to purchase and/or ship the replacement part may be examples of various transaction placement systems that may communicate with the verification system described herein.

As another example scenario, a third party may place an order (e.g. via an agent or a computer) for a new product or for a service technician to come and perform services. In such a situation, the third party may be a bad actor or the service technician could be a bad actor. In such a situation, the system used to place such an order may be another example transaction placement system that may communicate with the verification system described herein. As another example, an authorized retailer of products produced by the entity may, for example, provide service on the products it sells. The authorized retailer may be reimbursed by the entity (e.g., by placing a claim to the entity) for costs expended to service the products. In such a situation, the system used by the authorized retailer to place a claim may be another example transaction placement system that may communicate with the verification system described herein. In this situation, the authorized retailer, an employee of the authorized retailer and/or the customer that attempts to receive service from the retailer may be bad actors. Therefore, the preceding examples describe just a few examples of various transactions and transaction systems that may be targeted by bad actors. The system of the present disclosure may be versatile enough to verify transactions for all these types of systems and others.

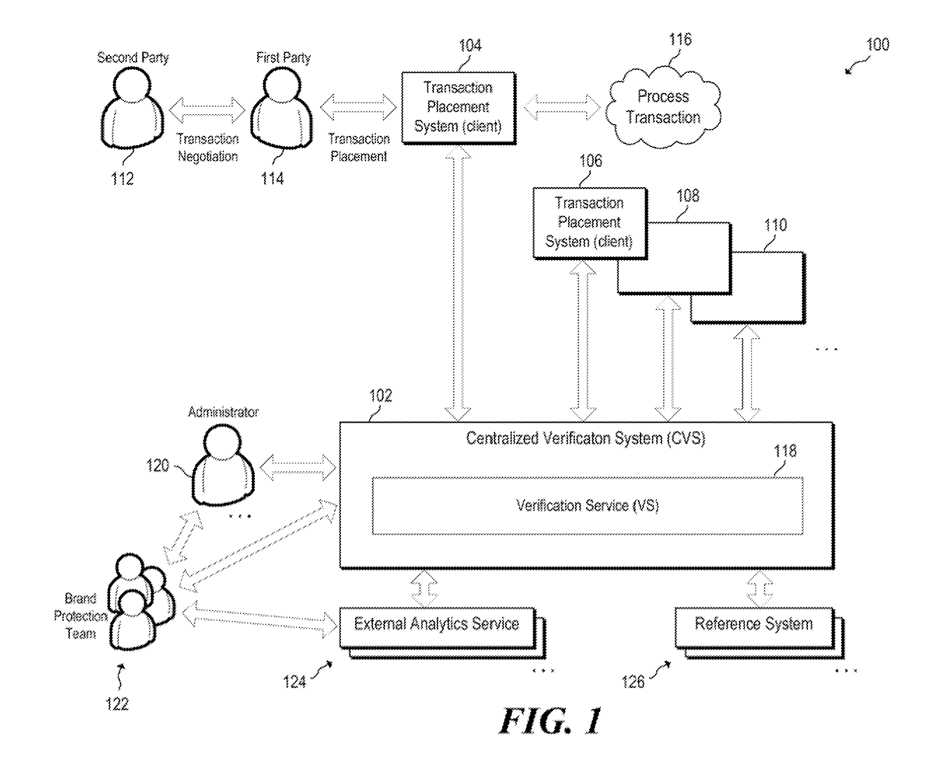

FIG. 1 is a block diagram of an example network setup 100, where a system for centralized versatile transaction verification may be used in such a network setup. Network setup 100 may include a centralized verification system 102 (or CVS for short). Network setup 100 may include a number of transaction placement systems, e.g., 104, 106, 108, 110, which may be in communication with CVS 102, for example, via a network (e.g., internet, intranet and/or the like). Transaction placement systems may also be referred to as “clients,” Transaction placement systems 104, 106, 108, 110 may send transaction data to CVS 102 and may receive responses in return (e.g., responses that indicate whether transactions should be allowed to complete or not).

FIG. 1 shows a depiction of one example transaction that may proceed, for example, with interactions between various parties (e.g., 112, 114) and a transaction placement system (e.g., 104). First party 114, as explained above, may be an employee or agent of an entity, where the transaction is related to the entity's business. First party 114 may interact with a transaction placement system 104, for example, to initiate a transaction (e.g., to place an order for a part). Second party 112 may negotiation with first party 114, for example, to cause first party 114 to initiate the transaction. In other situations, second party 112 may interact with a transaction placement system (e.g., 104) directly, e.g., without a first party present. In various situations, first party and/or second party may be bad actors. Once the transaction is initiated (e.g., via system 104), system 104 may communicate with CVS 102 to determine whether the transaction should be allowed to complete. If CVS 102 indicates that the transaction should be allowed to complete, transaction placement system 104 may complete the transaction, for example, by communicating with at least one other system (generally indicated by reference number 116).

Transaction placement systems 104, 106, 108, 110 may represent various types of systems for initiating various types of transactions. It should be understood that systems 104, 106, 108 and 110 may operate in different manners and may serve very different types of transactions (e.g., for different business organizations, segments, processes, regions, delivery channels, applications and the like). For example, one system may handle purchases of products and/or services, while another system may handle delivery of products and/or services, while another system may handle orders for reimbursement requests, and so on. In this respect, because of the potential wide range of types of transactions, the transaction placement systems of an example network setup 100 may be referred to as heterogeneous.

Central verification system (CVS) 102 may receive transaction data from multiple heterogeneous transaction placement systems (e.g., 104, 106, 108, 110). CVS 102 may be any computing device accessible to multiple client devices, for example, over the Internet or some other network. In some embodiments, CVS 102 may actually be more than one computing device. In other words, the components shown in CVS 102 and/or verification service 118 and/or 200 (e.g., modules, repositories, inputs, outputs, etc.) may be, but need not be, distributed across multiple computing devices, for example, computing devices that are in communication with each other via a network. In these embodiments, the computing devices may be separate devices, perhaps geographically separate. The term system or service may be used to refer to one computing device or multiple computing devices that are in communication as described above.

As can be seen in FIG. 1, CVS 102 may be implemented as a centralized system, which may offer significant advantages over previous transaction verification systems. For example, as mentioned above, CVS 102 may maintain a centralized knowledge base and centralized transaction verification code (e.g., both maintained in verification service 118). This may remove or lessen the burden of transaction placement systems (e.g., 104, 106, 108, 110) to maintain many separate knowledge bases and/or verification logic. Additionally, because such a knowledge base and/or logic may be maintained in a centralized manner, the knowledge base and logic may be secured. Ensuring the security of databases and logic used to combat risks may be important because if external entities (e.g., bad actors) are able to access even part of this information, they may use it to commit future bad actions. CVS 102 may ensure that knowledge and logic used to detect bad actions are set, altered and accessed at a single location. Additionally, CVS 102 may ensure that even if a bad actor were to gain access to CVS 102, the bad actor would not be able to understand the data in the knowledge base or the verification logic. For example, CVS 102 may encrypt, scramble or encode the information in the knowledge base and/or the verification logic.

Central verification system (CVS) 102 may include a verification service (VS) 118. CVS 102 may handle or process the transaction data, for example, via VS 118, as explained in more detail below. VS 118 (and CVS 102 generally) may include a series of instructions encoded on a machine-readable storage medium and executable by at least one processor accessible by the CVS 102 and/or VS 118. In some embodiments, CVS 102 may be implemented as a web server, and VS 118 may be implemented as a web-based service. VS 118 may use web server software, for example, open source web server software. The web server software may support a web-friendly instruction set such as JAVA or the like. In addition or as an alternative, VS 118 (and CVS 102 generally) may include one or more hardware devices including electronic circuitry for implementing the functionality described herein.

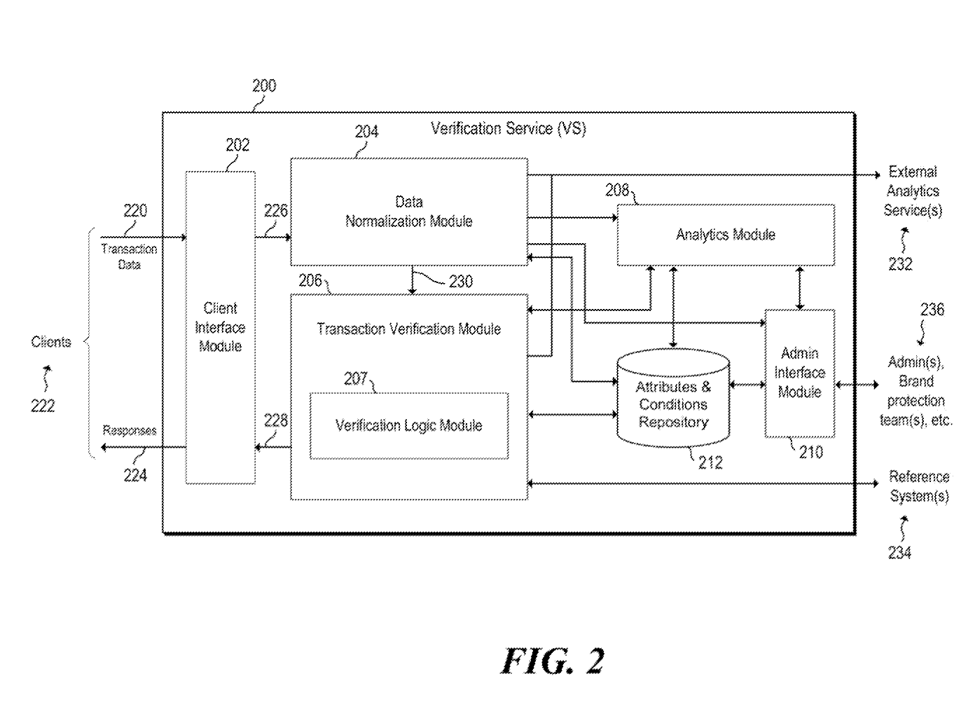

CVS 102 may allow for communication (e.g., via an admin interface) with at least one administrator 120 (or admin for short). CVS 102 may allow for communication by at least one member of a brand protection team 122. Members of the brand protection team 122 may communicate with CVS 102 via the same interface as administrator(s) 120 or via a different interface. In some scenarios, a brand protection team 122 may develop various conditions, rules and the like that may be used to configure CVS 102. In such scenarios, the brand protection team 122 may configure CVS 102 directly or they may communicate with administrator(s) 120 and then administrator(s) 120 may configure CVS 102. Central verification system (CVS) 102 may communicate with at least one external analytics system 124. Central verification system (CVS) 102 may communicate with at least one reference system 126. More details regarding example external analytics system(s) and example reference system(s) may be described in more detail below with regard to reference numbers 232 and 234 of FIG. 2.

FIG. 2 is a block diagram of an example verification service (VS) 200 for centralized versatile transaction verification according to the present disclosure. VS 200 may be similar to VS 118 of FIG. 1, for example. VS 200 may include a number of modules, for example, modules 202, 204, 206, 207, 208, 210. Each of these modules may include a series of instructions encoded on a machine-readable storage medium and executable by at least one processor accessible by VS 200. In addition or as an alternative, these modules may include one or more hardware devices including electronic circuitry for implementing the functionality described herein. VS 200 may include a number of repositories (e.g., 212). The term repository may generally refer to a data store that may store digital information. Each repository may include or be in communication with at least one physical storage mechanism (e.g., hard drive, solid state drive, tap drive or the like) capable of storing information including, for example, a digital database, a file capable of storing text, media, code, settings or the like, or other type of data store.

As can be seen in FIG. 2, VS 200 may receive transaction data 220 from clients 222, for example, transaction placement systems 104, 106, 108, 110. Clients 222 may be heterogeneous, meaning that they may serve various purposes and may be used to initiate various types of transactions. Transaction data 220 may be of various types and various formats, for example, depending on the client it came from and the type of transaction it relates to. In other words, transaction data 220 may be non-normalized. VS 200 may be able to accept and handle non-normalized data, which may insure that VS 200 may be compatible with various types of transaction systems. Various transactions systems may format their transaction data in various ways, and thus the ability to handle non-normalized data may be useful. Transaction data 220 may be received in real time, which means that clients may send transaction data to the CVS instantaneously once the client attempts to perform a transaction. Transaction data 220 may then quickly arrive at VS 200 and VS 200 may immediately or quickly start to handle the data.

Transaction data 220 may arrive at VS 200 as packets or bundles of transaction data, where each packet or bundle is associated with a particular transaction and a particular client. Each packet or bundle of data related to a transaction may include a number of pieces of transaction data. Each piece of transaction data may be used by VS 200 to determine whether the associated transaction should be allowed to complete. Examples of pieces of transaction data include customer information, business partner information, part and product information, obligation information, status indicators and many other pieces of transaction data. The part or product may be, depending on the transaction type, the part/product to be serviced, the part/product being ordered, the part/product to be replaced, the part/product being returned, etc. Even though transaction data 220 may arrive in various formats (e.g., depending on the client, etc.), each piece of transaction data may at least include an attribute name and an attribute value. The attribute name may include an identifier of the type of transaction data, for example, “serial number.” The attribute value may include the value of the piece of transaction data, for example, a serial number value of “XYZ123.”

VS 200 may receive each packet or bundle of data (e.g., part of transaction data 220) related to a transaction in a data dump manner. The term “data dump” may refer to sending and/or receiving data in an unorganized manner (or with little organization). An alternative to unorganized data may be data that is received according to an organization that is known and expected by the system (e.g., VS 200). For example, organized data may be entered via a form that has multiple defined and known entry fields. Then, when the organized data arrives at the system (e.g., VS 200), the system knows precisely which data pieces are associated with which fields. Additionally, when a system receives organized data, there may not be any additional data beyond what is associated with the defined fields. VS 200 may receive data in an unorganized or data dump manner such that a bundle of data may arrive without being associated with any particular input fields. The unorganized data may still include data pieces as attribute name/value pairs, but the attribute names, for example, may not be tied to any particular input field. VS 200 may then determine whether the attribute name is similar to an attribute that is being tracked by the system and/or may handle untracked attributes, as described more below.

VS 200 may send responses 224 to clients 222, for example, as a result of VS 200 analyzing transaction data 220. A particular response (in responses 224) may indicate, for particular a particular transaction, whether the transaction should be allowed to complete and/or whether a transaction should receive enhanced scrutiny. For example, a red light may indicate that the transaction should be stopped. A green light may indicate that the transaction should proceed. Other responses are possible as well. For example, a yellow light may indicate that the transaction may proceed with caution (e.g., the transaction is suspect). Responses may be formatted in various ways (e.g., other than color codes), for example, as text (e. “OK”, “STOP”, “WARNING”).

Clients 222 may use the response, for example, to determine whether to allow a transaction to complete. Clients may design processes that rely on the responses, and thus the responses may integrate into the client processes. In some situations, a first party (e.g., a call center agent or a channel partner administrator) may be trained to interpret and handle such responses. In some situations, the associated transaction placement system may handle the responses automatically. In some situations, the response (e.g., red light, green light, etc.) may not be visible to the first party, but the response may be used by the transaction placement system to perform at least one action based on the response (e.g., to notify some other system, service or individual). Thus responses may include additional indicators that may specify which individuals, components and the like should be able to view and/or use the response.

VS 200 may provide responses 224 to clients 222 in real time, which means that responses 224 may be sent to clients 222 shortly after the associated transaction data 220 is received by VS 200. This may allow for responses to be received by clients nearly at the time of the associated transaction. In some scenarios, VS 200 may, for a particular transaction, return a response 224 within a defined short time period (e.g., 1 second, 1.5 seconds, 2 seconds and the like) after VS 200 receives the associated transaction data 220.

Client interface module 202 may allow various clients 222 or transaction placement systems to communicate with VS 200. Client interface module 202 may determine whether a particular client may interact with VS 200. Clients may need to be configured in a particular way and/or authorized to communicate with VS 200. If client interface module 202 determines that a particular client is not able to (e.g., not authorized to) interact with VS 200, module 202 may return an error message or may not return any information. In this respect, it may be said that the CVS and/or the VS 200 has a “controlled” system interface. As mentioned above VS 200 may receive transaction data in a data dump manner. Client interface module 202 may receive, for various transactions from various clients, data dumps where each data dump includes a number of pieces of transaction data, each piece of transaction data including an attribute name/value pair. Client interface module 202 may be able to interpret at least one markup language (e.g., XML, JSON, etc.), for example, to handle transaction data that may be formatted according to such a markup language. A markup language may be a useful way, for example, to express attribute name/value pairs.

Client interface module 202 may receive, for each transaction, any number of pieces of transaction data. Module 202 may receive pieces of transaction data for attributes that are known or tracked by the VS 200. Module 202 may also receive pieces of transaction data for attributes that are not yet known or tracked by the VS 200. VS 200 may then analyze these new attributes to determine whether such attributes should be tracked, as described more below. Client interface module 202 may pass (e.g., via link 226) transaction data 220 on to at least one other module (e.g., module 204) of VS 200.

Client interface module 202 may receive (e.g., via link 228) responses from transaction verification module 206. As described above, a response, for a particular transaction, may indicate whether the transaction should be completed. Module 202 may communicate the responses (e.g., as responses 224) to clients 222. Responses 224 may be formatted in a generic manner (e.g., red light, green light, yellow light, etc.), such that, for example, clients 222 are only able to see whether a particular transaction should proceed. Clients 222 may not be able to see any of the logic, routines, attributes, conditions, checks and the like that occur within VS 200.

Client interface module 202 may determine, for a particular transaction, the type of client that VS 200 is communicating with (e.g., a computer sales system, a replacement part shipment system, etc.). For example, clients 222 may send a client ID or transaction system ID that allows module 202 to determine the type of system and/or the general type of transactions that the system handles. Client interface module 202 may communicate this client type information to other modules of VS 200. VS 200 may use this client type information to provide differentiated experiences to different types of clients, for example, based on the characteristics of the system and/or transaction. As one particular example, if a transaction placement system handles service delivery requests. VS 200 may generate a response (e.g., 224) to block some transactions and increase services for others. As another particular example, for some transaction placement systems and/or types of transactions, VS 200 may return various responses for various purposes and/or recipients. Thus, in some situations, a user may not see a response (e.g., a red light or a green light), but the transaction placement system may receive the response, and may perform at least one action based on the response (e.g. to notify some other system, service or individual).

Data normalization module 204 may receive, for various transactions, transaction data (e.g., via link 226) from client interface module 202. As described above, the transaction data may be non-normalized (e.g., various formats) and/or unorganized (e.g., associated with no particular data fields). The transaction data, for a particular transaction, may include multiple pieces of transaction data, e.g., each one represented as an attribute name/value pair. VS 200 may track or be aware of various attribute names as described in more detail below. In some embodiments and/or situations, VS 200 may provide a “dictionary” to clients that indicates the attributes that VS 200 may track. Clients may use such a dictionary to determine which attribute name/value pairs to send to VS 200. Clients may send transaction data that includes any number of transaction data pieces associated with any number of the attributes in the dictionary. Clients may also send transaction data pieces for attributes that are not in the dictionary.

Clients may not be aware of how the transaction data pieces are being used by CVS and/or VS 200. In some situations, clients may not be provided with a dictionary and may not know which attributes are tracked by the CVS and/or VS 200. Clients may just send any amount of transaction data to the CVS/VS (e.g., as black box), and then may receive a response (e.g., 224) in return. In some situations, because little or no information is provided to clients regarding what attributes are used by the CVS/VS 200, the criteria used by the CVS/VS to verify transactions may be secured in the centralized CVS/VS. This may reduce the risk that any one client or any party communicating with a client may determine the criteria used and, for example, design transaction data in a way that may evade the verification routines of the CVS/VS.

Data normalization module 204 may determine which attributes are being tracked by VS 200, for example, by communicating with attributes and conditions repository 212. In some situations, information (tracked attributes) in repository 212 may be cached for quick access by modules of VS 200, for example module 204. Data normalization module 204 may determine (e.g., by communicating with repository 212), for each attribute being tracked, an attribute name formatting and an associated value formatting. The attribute name formatting may specify the precise format in which VS 200 maintains the attribute name. For example, for a product number attribute, there can be different formats for the name of the attribute (e.g., all caps or not, with/without spaces, with/without underscores, etc.). As another example, some attributes may have synonyms or aliases. The attribute value formatting may specify a preferred formatting for the attribute value. For example, for a product number attribute, there can be different formats for the value of the product number (e.g., all caps or not, with/without dashes, with/without leading letters, etc.). As another example, mailing addresses can be presented in a variety of formats. As yet another example, phone number may include letters, and the preferred value format may require only numbers.

For each incoming (e.g., via link 226) transaction data packet, data normalization module 204 may determine whether each associated attribute is being tracked. For example, for each attribute name, module 204 may scan all the tracked attributes (e.g., in repository 212), for example, where each tracked attribute name is formatted according to a preferred attribute name format as described above. If the incoming attribute name (e.g., a text string) is similar (e.g., within a certain degree of error) to one of the tracked attribute names (e.g., a text string), module 204 may determine that the attribute is tracked. If the attribute is being tracked, module 204 may alter the incoming attribute name to conform it to the preferred attribute name format. Module 204 may also alter the incoming attribute value to conform to the preferred attribute value format. In this respect, various types of incoming non-normalized transaction data (e.g., from wide variety of systems and uses) may be normalized into a master format before VS 200 verifies the data (e.g., via module 206). Module 204 may send (e.g., via link 230) normalized transaction data (e.g., attribute name/value pairs) to transaction verification module 206.

Data normalization module 204 may also be able to handle attributes that are not being tracked. At module 204, if the incoming attribute name (e.g., a text string) is not similar (e.g., within a certain degree of error) to one of the tracked attribute names (e.g., a text string), module 204 may send the attribute name and/or value to analytics module 208. Analytics module may log the uses of untracked attributes. Analytics module 208 may perform various routines and/or checks that may determine, at some point, that a frequently used but untracked attribute should be tracked by VS 200. Analytics module 208 may present information about frequently used but untracked attributes to admin interface module 210, via which an administrator may see such attributes and may determine whether such attributes should be tracked (e.g., by adding the attributes to repository 212). Thus, VS 200 may start to track untracked attributes logged by analytics module 208 automatically or with input from at least one administrator. It should be understood that analytics module may also log the uses of tracked attributes, as described in more detail herein.

Data normalization module 204 may communicate various pieces of data that it receives to at least one external analytics service 232. External analytics service(s) may be similar to external analytics service(s) 124, for example. As one example, module 204 may communicate, for each transaction, all the attribute name/value pairs received. Additionally, module 204 may send other statistical information such as time stamps of arriving data, information about clients 222, and the like. External analytics service(s) 232 may also receive information from transaction verification module 206, for example regarding verification conclusions that were made on various transactions. External analytics service(s) 232 may use this conclusion information along with all the “raw transaction data” from module 204 to perform post-transaction analysis, for example, to determine the effectiveness of the conditions (e.g., in 212) and/or the verification logic (e.g. in 207), and the like.

External analytics service(s) 232 may also receive information from other systems, e.g., systems maintained by the same entity that maintains the CVS. External analytics service(s) 232 may essentially perform data analysis, data mining or the like on the data sent by VS 200 and other systems. In some situations, external analytics service(s) may be implemented as a type of business intelligence environment. External analytics service(s) 232 may analyze the data it receives to determine trends, patterns, risks and the like that may be useful, for example, to a brand protection team. The information generated by external analytics service(s) 232 may be used by a brand protection team and/or administrators to develop new conditions, for example, to be entered into repository 212.

Transaction validation module 206 may receive (e.g., via link 230) normalized transaction data from data normalization module 204. Transaction validation module 206 may analyze, for various transactions, the received transaction data to detect various situations of interest (e.g., bad actions/brand attacks). In general, module 206 may compare received attributes (e.g., name/value pairs) to various conditions (e.g., from repository 212). Transaction validation module 206 may include verification logic module 207 which may receive such conditions and assemble the conditions into a logical unit that module 206 may use to verify incoming transaction data. Transaction validation module 206 may also communicate with analytics module 208 and at least one reference system 234, as described in more detail below.

Attributes and conditions repository 212 may indicate which attributes are tracked by VS 200, and may store conditions that apply to the various attributes that are tracked. Attributes and conditions repository 212 may be referred to as a “knowledge base,” for example, because it may indicate various risks, risk factors, scenarios of interest, and the like that may be used by VS 200 to verify transactions. As mentioned above, the present disclosure describes a centralized knowledgebase, which allows the CVS and VS 200 to utilize knowledge gained or maintained for one type of system/transaction for another type of transaction/system.

The term “condition” may refer to a step or routine that should be performed (e.g., setting a response message) if an attribute matches a particular value, pattern, set of data or the like. Each condition may check for a particular known problem, risk or risk factor. For example, a condition may check that a “serial number” attribute matches one of the known serial numbers of the entity. As another example, it may be known that certain entity is a bad actor (e.g., performing non-compliant activity). One simple condition may specify that if, for a particular transaction, the transaction data includes a “name” attribute, and if the value of the name attribute is equal to “John Smith” (the known bad actor), then a red light response should be returned to the client, indicating that the transaction should be stopped. Conditions may include comparisons to multiple attributes.

Attributes and conditions repository 212 may also store rules. Rules may be similar to conditions, but may provide more flexibility on how attributes may be monitored. Rules may check whether attribute values (e.g., a string) conform to a particular pattern, range or the like. Other rules may check for a length of a particular attribute value or the types of character used in the value. Many other rules may be used, for example, rules that use wildcards or other placeholders.

Attributes and conditions repository 212 may also store exceptions. Exceptions may be associated with particular conditions and may cause the step or routine associated with the condition to be ignored if an attribute matches a particular value. For example, if a particular transaction triggered the “John Smith” condition explained above, an exception may specify that transactions initiated by a pa trusted retailer (e.g., Company XYZ) may be allowed. In such a situation, the attribute name may be “retailer,” for example, and the attribute value may be “Company XYZ.” Other exceptions may allow transactions in a particular geographical area, for example.

Attributes and conditions repository 212 may also store exclusions. Exclusions may cause the step or routine associated with the condition to be ignored if an attribute matches a particular value. Exclusions, unlike exceptions may not be associated with any particular condition. Instead, exclusions may be more similar to conditions themselves in that they may be the start of particular related group of attribute checks. As an example, all transactions initiated by a trusted service provider may be allowed, e.g., regardless of the other attributes included in the transaction data. Other example exclusions may allow transactions to complete for particular countries, product lines, etc. Attributes and conditions repository 212 may also store exceptions that are related to exclusions, which may cause the step or routine associated with the exclusion to be ignored if an attribute matches a particular value.

Various descriptions provided herein may refer to “conditions”, for example, with regard to repository 212, verification logic module 207 and other modules of VS 200 and CVS generally. It should be understood that the term condition when used in the various descriptions herein may be used in a flexible manner to refer to a condition per se, as defined above, or it may refer to a rule, an exception or an exclusion. Some conditions, exceptions and/or exclusions may be global (e.g., applicable regardless of where the transaction takes place) and some may be local (e.g., applicable to transactions that take place in a particular area). Likewise, exceptions and/or exclusions can be global or local. Conditions, exceptions, filters and the like may be combined to narrow a check on a particular transaction. For example, a broad condition may be created. Then a more narrow condition (i.e., a filter) may be added. Then an exclusion may be added, which may further narrow the check. As described below, module 207 may be able to combine these various conditions, exceptions, exclusions, filters and the like to create smart verification logic.

Attributes and/or conditions in repository 212 may be provided, removed and/or modified by admin interface module 210 and/or by analytics module 208. Administrators, brand protection teams and the like (generally indicated by reference number 236 and similar to 120 and 122 of FIG. 1) may interact with admin interface module 210 to add, remove and/or modify attributes and/or conditions. As one particular example, a brand protection team may receive information from at least one investigation and/or information from an external analytics service (e.g., 232) and may determine various risk factors and situations of interest. The brand protection team may then formulate at least one condition to detect such situations. Admin interface module 210 may allow for direct alteration of information in repository 212, for example, via a graphical user interface. Admin interface module 210 may also allow administrators to simulate transactions (e.g., via the graphical user interface), for example, to test the response of at least one conditions. Analytics module 208 may also provide attributes and conditions, as explained in more detail below. Thus, it can be seen that attributes and conditions in repository 212 may come from a variety of sources.

Conditions in repository 212 may be unstructured, meaning that the various conditions in repository 212 may be more or less designed without consideration of the other conditions in repository 212 and/or without consideration of the effect of some conditions on other conditions. In other words, the conditions may not be pre-organized (e.g., while in repository 212) according to a decision tree, unified logic structure, or other organized step-by-step way in which the conditions should be considered. As described herein, conditions may be created and entered into the CVS by various parties and thus the conditions may each be more or less independent of each other. In some situations, multiple conditions or a group of conditions may be related and structured together, but overall, the conditions in repository 212 may not be structured.

Table 1 below shows an example set of conditions that may be useful to describe various concepts provided above. As can be seen in Table 1, condition 1, condition 2 and exclusion 3 may be unrelated. However, filter 1, and exceptions 1 and 2 may be related to condition 1. In various descriptions here, all of these conditions, filters, exceptions and exclusions may generally be referred to as conditions. It can be seen that some sub-sets of the set of conditions may be related (e.g., Condition 1, filter 1, exception 1, exception 2). Yet, overall, the conditions may not be related (e.g., they are unstructured).

TABLE 1
Example set of conditions:

Condition 1

Filter 1 (a more narrow condition)
Exception 1 (related to condition 1)
Exception 2 (related to condition 1)

Condition 2
Exclusion 3

Exception 3 (related to exclusion 3)

As described below, transaction verification module 206 and verification logic module 207 may be able to handle unstructured conditions, even if the unrelated conditions conflict, overlap and the like. The ability for the CVS and VS 200 to handle unstructured conditions may provide benefits over other verification systems, for example, because conditions may be added to the system without having to cycle back through all the existing conditions to ensure compatibility. Additionally, conditions may be added a single time to the system, unlike other verification systems, for example, where a decision tree structure may require a particular condition to be duplicated in multiple branches of the tree (e.g., a condition that checks for a particular retail store may exist in a tree branch for printers and for laptops).

Repository 212 may provide its various conditions to module 206, and particularly to module 207. As described below, modules 207 may combine various conditions to create verification logic to analyze transaction data (e.g., received from module 204). When various conditions are triggered, a message that may eventually be sent as part of a response (e.g., 224) may be altered. Once the response message has been altered according to relevant conditions, the response may be sent to the appropriate client.

Verification logic module 207 may receive and/or access the conditions in repository 212. Verification logic module 207 may validate transaction data received from module 204 for various transactions against conditions from repository 212. Transaction verification module 207 may dynamically create tailored verification logic for any subset of conditions that are relevant to a particular transaction (e.g., rather than creating a decision tree for all conditions in repository 212). Such tailored verification logic may significantly reduce processing time required for module 207 to verify any particular transaction. To create such a subset, verification logic module 207 may determine, for a particular transaction, which conditions are relevant to the transactions. This may include determining, for each piece of transaction data, which conditions use the same attribute as the pieces of transaction data. Because attributes in both repository 212 and transaction data received from module 204 may be formatted according to a preferred formatting, such a determination (e.g., comparison) may be easy. Once all the conditions for a particular transaction are identified, verification logic module 207 may assemble or walk through the conditions and may alter a response message (e.g., to be sent at link 228) related to the particular transaction.

As described above, the conditions in repository 212 may be unstructured, and thus one condition may overlap, supersede with or conflict with, at least partially, another condition. In some situations, various conditions may be related and may be designed to not conflict with each other (e.g., Condition 1, filter 1 exception 1, exception 2 in Table 1 above). However, unrelated/unstructured conditions and/or conditions groups may conflict. Verification logic module 207 may be able to handle such unstructured conditions and may determine how to resolve conflicting conditions and/or may determine which conditions may take precedence. For example, if only a single condition matches the attributes for a particular transaction, then the resolution may be easy (e.g., a condition that specifies that if “name”=“John Smith,” set the response message to red or “STOP”). However, if multiple conditions match the attributes of a particular transaction, then verification logic module 207 may resolve the conflict. As an example of a conflict, a first condition may specify that if the count of some specific attribute is greater than 100, then the response message should be set to yellow. A second condition may specify that if the count is greater than 200, then the response message should be red. In this situation, module 207 may determine that these overlapping rules can exist together because the first condition, when triggered, may be mapped to a yellow response and the second condition, when triggered, may be mapped to a red response. It should be understood that in some implementations, as module 207 considers or walks through various conditions for a particular transaction, the associated response message may be set or updated multiple times. In the example above, the message may be set a first time to yellow (e.g., because the count is greater than 100) and may be updated later (e.g., because the count is greater than 200).

Transaction verification module 207 may employ various rules or guidelines to determine how to resolve conflicts between various unrelated conditions. For example, module 207 may determine that some conditions are more specific or narrow than others, and may give precedence to such conditions. As another example, some conditions may be associated with a more severe response message (e.g., red) than others (e.g., yellow or green), and module 207 may give precedence to conditions that are associated with more severe messages. As another example, various conditions may be associated with an importance, and module 207 may give precedence to rules with a higher importance. The importance for various conditions may be stored in repository 212 and may be set via module 208 and/or module 210 (e.g., provided by an administrator). As another example, if multiple conditions overlap and conflict, module 208 may give precedence to an earlier entered condition (e.g., according to the date the condition was entered or refreshed in repository 202).

Transaction verification module 207 may combine these various conflict resolution rules and/or guidelines, and may consider the various conditions relevant to a particular transaction to create smart, quick verification logic that may be used to verify the transaction. The verification logic created by module 207 may provide benefits over other transaction verification systems that may assemble conditions or rules into static binary decision trees. A binary decision tree consists of multiple questions with two branches extending out from each question. For example, a binary decision tree may include one branch for laptops and another branch for printers. Then, in each of those branches, the binary decision tree may check, for example, whether a serial number matches a particular format. Thus, it can be seen that a single check or condition may be duplicated. Additionally, because the binary decision tree may be assembled for all the conditions in a database, a verification process for a single transaction may include asking several irrelevant questions.

Transaction verification module 207, by using only relevant conditions, and by not rigidly or statically designing the logic, in effect, creates a dynamic multi-split decision tree. Such a dynamic decision tree is comparable to having a decision tree where all irrelevant questions and related branches are pruned out of the tree, and where the tree can have multiple branches extending out from any particular question. In other words, the verification logic is dynamic and adaptable.

Transaction verification module 207 may also provide benefits over other verification services in that parties that create and/or enter condition into the system need not know about the details of the verification logic (e.g., the tree). Because module 207 can handle unstructured conditions in a dynamic manner, creators of conditions can focus on creating useful conditions and need not worry about how the conditions fit into the tree/verification logic. For example, creators of conditions need not worry about how various conditions may overlap, conflict, etc. This may be opposed to other verification systems where the rules, checks conditions or the like are closely related to a decision tree. In such systems, creators of conditions must understand the structure of the tree (which may be complex) and must consider the structure when creating new conditions.

Once transaction verification module 207 has considered all the conditions that are relevant to a particular transaction, and once module 207 has, potentially, updated the associated response message based on the conditions, transaction verification module 206 may send (e.g., via link 228) the response to client interface module 202. Module 202 may then send the response 224 to clients 222, as described in more detail above.

Transaction verification module 206 (and/or module 207) may communicate with at least one reference system 234. Reference system(s) 234 may be similar to reference system(s) 126 of FIG. 1, for example. Module 206 may communicate with reference system(s) 234 to compare attribute values for various transactions to known and trusted sources. For example, a reference system may maintain a pool of valid serial numbers (and/or product numbers), for example, for a particular entity and for all products (or a group of products) in one centralized location. In particular, such a reference system may be referred to as a serial number repository. Other example reference systems may maintain lists of valid or trusted partners, customers or the like. Conditions (e.g., in repository 212) may be designed to reference at least one of these reference systems, or may be designed to check a situation that requires communication with one of these reference systems. For example, a condition may specify that if the value of the “serial number” attribute is “valid,” then set the response message to green. Then module 206 and/or module 207 may communicate with a reference system to determine whether a serial number for a particular transaction is valid.

Analytics module 208 may dynamically analyze transaction data for various transactions over time, and may perform various steps and/or routines (e.g., creating new conditions) based on patterns that manifest in the transaction data. Analytics module 208 may receive (e.g., from module 204) transaction data for all transactions sent to VS 200, and may log the transaction data. As described above, analytics module 208 may log transaction data related to untracked attributes. If analytics module 208 detects that a particular untracked attributed is frequently used, module 208 may cause the attribute to be tracked. Additionally, analytics module 208 may log transaction data related to tracked attributes, as well as any other data related to the transaction.

Analytics modules 208 may analyze currently received and/or logged transaction data to detect patterns in the data. As one example, module 208 may detect reoccurring similar transactions (e.g., transactions that occur with regard to the same serial number). Then, conditions (e.g., in repository 212) may be designed to perform checks related to information that may be provided by analytics module 208. For example, a condition may specify that if more than 10 replacement part transactions occur in a single day for the same serial number, then the transaction should be stopped. Conditions may be defined based on absolute counts of a single attribute or relative counts of an attribute compared to another attribute. For both types of counts, the condition may be triggered once the count reaches a certain threshold. For example, the number of parts ordered per unit can be monitored so that if the volume is too high, a warning is triggered. Thus, it can be seen that conditions may be designed based on the accumulation of transaction data over time. Then, when transaction verification module 206 is verifying a particular transaction, module 206 may communicate with analytics module to determine whether an accumulation (e.g., specified by a particular condition) has occurred.

Analytics module 208 may allow VS 200 to learn and/or adapt based on the logged transaction data (e.g., patterns in the data), and may cause VS 200 to take various actions (e.g., create new attributes) based on the logged data. Analytics modules 208 analyze logged transaction data to detect suspicious or interesting patterns in the data. Based on such detections, analytics module 208 may indicate (e.g., to module 206 and/or module 210) that a suspicious or interesting pattern of transactions has been detected. In other words, creators of conditions may not always know what patterns, data accumulations and the like that they should be interested in. Analytics module 208 may detect patterns that exist, for example, based on combinations of attributes. For example, module 208 may detect a series of transactions that are highly unlikely to occur in the normal course of business. Module 208 may use various “guiding factors” to help it determine what it should look for in the transaction data. These guiding factors may be set or provided by system administrators, for exam pie.

Analytics module 208, in some scenarios, may indicate to module 206 that it has detected a suspicious transaction pattern, and may directly suggest to module 206 that the related transaction be stopped. In other scenarios, module 206 may cause an attribute to be added or a condition to be created and added to repository 212 based on the detection of a suspicious pattern. In other scenarios, module 208 may indicate to administrators (e.g., via module 210) that it has detected a suspicious transaction data pattern. Then, administrators may analyze the data and may confirm or deny to module 208 that the pattern is a concern. In this respect, module 208 may learn (e.g., using machine learning) whether its detection factors and/or routines are correct and/or it may alter its detection factors and/or routines. Also, in response to an indication from module 208, administrators may create new conditions and add them to repository 212. Alternatively or in addition, module 208 may, upon confirmation of a suspicious pattern, for example, automatically and dynamically add related conditions to repository 212 or modify conditions that exist in repository 212.

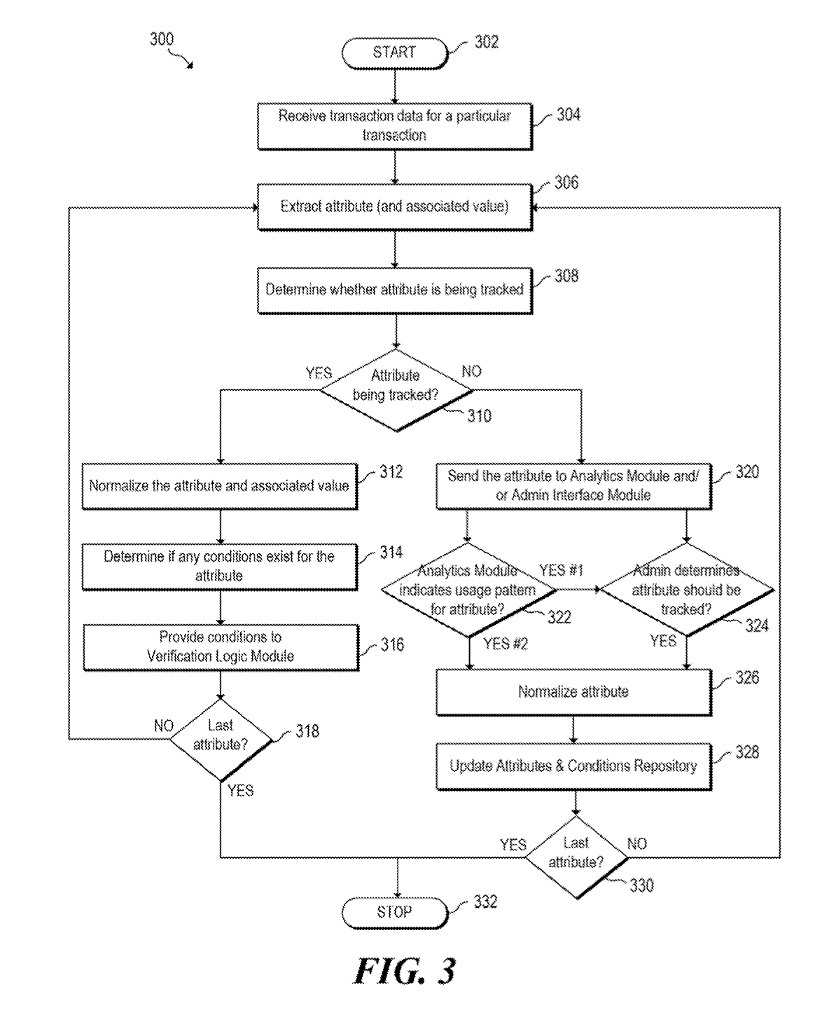

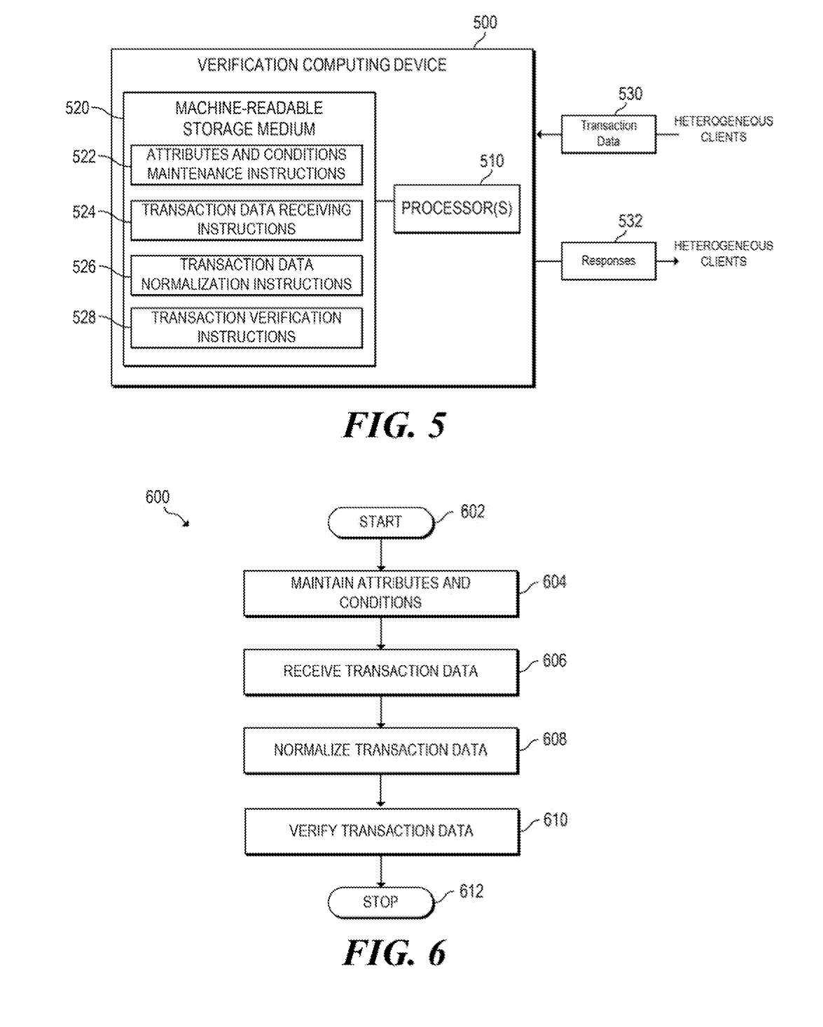

FIG. 3 is a flowchart of an example method 300 for centralized versatile transaction validation. Specifically, method 300 may relate to handling non-normalized transaction data (e.g., transaction data 220 received from clients 222). Method 300 may be executed by a centralized verification system (CVS), for example, similar to CVS 102 of FIG. 1. Method 300 may be executed by other suitable systems and/or computing devices, for example, computing device 500 of FIG. 5. Method 300 may be implemented in the form of executable instructions stored on a machine-readable storage medium, such as storage medium 520, and/or in the form of electronic circuitry. In alternate embodiments of the present disclosure, one or more steps of method 300 may be executed substantially concurrently or in a different order than shown in FIG. 3. In alternate embodiments of the present disclosure, method 300 may include more or less steps than are shown in FIG. 3. In some embodiments, one or more of the steps of method 300 may, at certain times, be ongoing and/or may repeat.

Method 300 may start at step 302 and continue to step 304, where CVS 102 may receive (e.g., via module 202) transaction data (e.g., transaction data 220 from a client 222) for a particular transaction. As described above, the transaction data may be non-normalized and unorganized. At step 306, CVS 102 may extract a first or next piece of transaction data (e.g., attribute name and associated value). At step 308, CVS 102 may determine (e.g., via module 202) whether the extracted attribute is being tracked. As described above, module 202 may reference an attributes and conditions repository (e.g., 212) and determine whether the extracted attribute (e.g., a text string) is similar (e.g., within a degree of error) to an attribute (e.g., a text string) in the repository. At step 310, if the attribute is being tracked, method 300 may proceed to step 312, and if the attribute is not being tracked, method 300 may proceed to step 320.

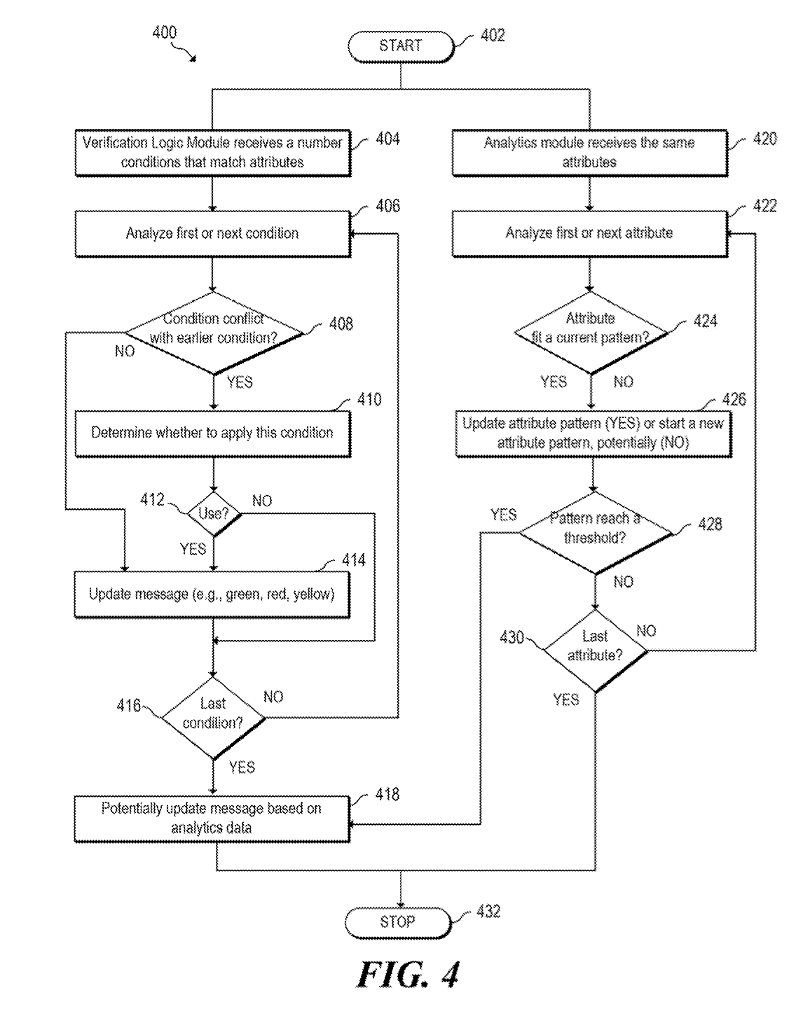

At step 312, CVS 102 may normalize (e.g., via module 204) the extracted attribute (e.g., the attribute name and the associated value) to conform to a preferred name and value formatting, as described above. At step 314, CVS 102 may determine (e.g., via module 206) whether any conditions exist (e.g., in repository 212) that relate to the extracted attribute. If no related conditions exist, CVS 102 may return a response to the client that the transaction is verified (e.g., a green light message may be generated at step 414 of FIG. 4). At step 316, CVS 102 may provide any relevant conditions to a verification logic module (e.g., 207). For example, the verification logic module may communicate with repository 212 to access relevant conditions. At step 318, if the extracted attribute is the last attribute in the received transaction data, method 300 may proceed to step 332, and if the extracted attribute is not the last attribute, method 300 may return to step 306 and the next attribute (name and associated value) may be extracted from the transaction data.

At step 320, if the extracted attribute is not being tracked, CVS 102 may send (e.g., via module 204) the attribute to an analytics module (e.g., 208) and/or an admin interface module (e.g., 210). It should be understood that, even if the extracted attribute is being tracked, CVS 102 may still send the attribute (and perhaps other data related to the transaction) to the analytics module. At step 322 if the analytics module determines that an attribute usage pattern exists, method 300 may proceed in at least one way. Method 300 may proceed to step 324 based on an indication of the usage pattern being sent to an administrator. Additionally or alternative, method 300 may proceed to step 326 based on the analytics module determining that the attribute should be tracked. At step 324, an administrator may receive (e.g., via module 210) an indication of a usage pattern for an untracked attribute and/or the administrator may receive indications of untracked attributes individually as they are used. The administrator may determine and indicate (e.g., via module 210) that the attribute should be tracked, in which case method 300 may proceed to step 326. At step 326, CVS 102 may normalize the attribute (e.g., name and value) according to a preferred format, before the attribute starts to be tracked. At step 328, CVS 102 may update the attributes and conditions repository (e.g., 212) to start tracking the attribute. At step 330, if the extracted attribute is the last attribute in the received transaction data, method 300 may proceed to step 332, and if the extracted attribute is not the last attribute, method 300 may return to step 306 and the next attribute (name and associated value) may be extracted from the transaction data. Method 300 may eventually continue to step 332, where method 300 may stop.

FIG. 4 is a flowchart of an example method 400 for centralized versatile transaction validation. Specifically, method 400 may relate to verifying a transaction (e.g., via module 206) and the use of verification logic (e.g., 207). Method 400 may be executed by a centralized verification system (CVS), for example, similar to CVS 102 of FIG. 1. Method 400 may be executed by other suitable systems and/or computing devices, for example, computing device 500 of FIG. 5. Method 400 may be implemented in the form of executable instructions stored on a machine-readable storage medium, such as storage medium 520, and/or in the form of electronic circuitry. In alternate embodiments of the present disclosure, one or more steps of method 400 may be executed substantially concurrently or in a different order than shown in FIG. 4. In alternate embodiments of the present disclosure, method 400 may include more or less steps than are shown in FIG. 4. In some embodiments, one or more of the steps of method 400 may, at certain times, be ongoing and/or may repeat.

Method 400 may start at step 402 and continue (e.g., concurrently) to step 404 and step 420. At step 404, CVS 102 may receive (e.g., via verification logic module 207), for a particular transaction, a set of conditions that match attributes in the transaction data for the transaction. At step 406, CVS 102 (erg, module 207) may analyze the first or next condition in the set. At step 408, if the condition conflicts with an earlier condition analyzed for the same transaction, then method 400 may proceed to step 410. Otherwise, method 400 may proceed to step 414. At step 410, CVS 102 (e.g., via module 207) may determine whether to apply the current condition. For example, as described above, if the current condition conflicts with a previously analyzed condition that takes precedence over the current condition, then the current condition may not be applied. Various other rules or guidelines may be used to determine how to resolve conflicts between the current condition and previously received conditions, e.g., as explained in more detail above with regard to transaction verification module 207.

At step 412, if CVS 102 determines that the current condition will be applied, method 400 may proceed to step 414. Otherwise, method 400 may proceed to step 416. At step 414, CVS 102 (e.g., via module 206 and/or 207) may update the response message associated with the particular transaction. CVS 102 may update the response message by applying the current condition. For example, if an attribute specified by the condition fits a current value, range or the like, the response message may be updated. Various conditions may be arranged and applied as described above, for example, with regard to the discussion of conditions, rules, exceptions, exclusions and the like. The response message may be updated even if the response message was previously updated by applying previous conditions. In other words, a current condition may overwrite a previous condition. At step 416, CVS 102 may determine whether the current condition is the last condition in the set of conditions. If so, method 400 may proceed to step 418. Otherwise, method 400 may return to step 406 where the next condition may be analyzed. At step 418, CVS 102 may update the response message based on analytics data (e.g., data from module 208) that may suggest a suspicious pattern has been detected in the transaction data. Method 400 may eventually continue to step 432, where method 400 may stop.

At step 420, CVS 102 may receive (e.g., via analytics module 208) the various attributes (names and values) of the transaction data for the particular transaction. At step 422, CVS 102 may analyze (e.g., via module 208) the first or next attribute. At step 424, CVS 102 may determine whether the attribute fits a current pattern that is being maintained or tracked. At step 426, if the attribute fits a current pattern, the pattern may be updated (e.g., to indicate another event that conforms to the pattern). Also at step 426, if the attribute does not fit a current pattern, CVS 102 may potentially start to maintain or track a new pattern. At step 428, CVS 102 may determine whether any of the maintained patterns has reached a threshold. The threshold may be determined by a condition e.g., in repository 212) or this threshold may be determined by the analytics module. If a threshold has been met, method 400 may proceed to step 418. Otherwise, method 400 may proceed to step 430. At step 430, CVS 102 may determine whether the current attribute is the last attribute in the transaction data for the particular transaction. If so, method 400 may proceed to step 432, where method 400 may stop. Otherwise, method 400 may return to step 422 where the next attribute may be analyzed.

FIG. 5 is a block diagram of an example verification computing device 500 for centralized versatile transaction validation. Verification computing device 500 may be any computing device accessible to multiple client devices, for example, over the Internet or some other network. In some embodiments, verification computing device 500 may actually be more than one computing device, in which case, multiple processors and/or machine readable mediums may be involved. More details regarding an example centralized verification system and/or verification service may be described above, for example, with respect to CVS 102 of FIG. 1, VS 118 120 of FIG. 1 and/or VS 200 of FIG. 2. In the embodiment of FIG. 5, verification computing device 500 includes at least one processor 510 and a machine-readable storage medium 520.

Processor 510 may be one or more central processing units (CPUs), CPU cores, microprocessors, and/or other hardware devices suitable for retrieval and execution of instructions stored in a machine-readable storage medium (e.g., 520). Processor 510 may fetch, decode, and execute instructions (e.g., instructions 522, 524, 526, 528) to, among other things, provide centralized versatile transaction validation. With respect to the executable instruction representations (e.g., boxes) shown in FIG. 5, it should be understood that part or all of the executable instructions included within one box may, in alternate embodiments, be included in a different box shown in the figures or in a different box not shown.

Machine-readable storage medium 520 may be any electronic, magnetic, optical, or other physical storage device that stores executable instructions. Thus, machine-readable storage medium 520 may be, for example, Random Access Memory (RAM), an Electrically-Erasable Programmable Read-Only Memory (EEPROM), a storage drive, an optical disc, and the like. Machine-readable storage medium 520 may be disposed within a computing device (e.g., 500), as shown in FIG. 5. In this situation, the executable instructions may be “installed” on the computing device. Alternatively, machine-readable storage medium 520 may be a portable (e.g., external) storage medium, for example, that allows a computing device (e.g., 600) to remotely execute the instructions or download the instructions from the storage medium. In this situation, the executable instructions may be part of an installation package. As described below, machine-readable storage medium 520 may be encoded with executable instructions to provide centralized versatile transaction validation.

Attributes and conditions maintenance instructions 522 may maintain a set of attributes that are known to the system. Each attribute in the set may have an attribute formatting and an associated value formatting. Instructions 522 may also maintain a set of conditions, where each condition is associated with at least one of the known attributes in the set of attributes. More details regarding maintaining attributes and conditions may be described above, for example, with regard to repository 212 of FIG. 2. Transaction data receiving instructions 524 may receive transaction data from multiple transaction placement systems (clients). Instructions 524 may accept, for each client, for a particular transaction, any number and type of transaction data pieces. More details regarding receiving transaction data may be described above, for example, with regard to module 202 of FIG. 2. Transaction data normalization instructions 526 may normalize received transaction data such that, for each transaction data piece, if the associated attribute is similar to a known attribute in the set of attributes, the associated attribute and value may be altered to follow, respectively, the attribute formatting and value formatting of the similar known attribute. More details regarding normalizing transaction data may be described above, for example, with regard to module 204 of FIG. 2. Transaction verification instructions 528 may determine whether received transactions should be allowed based on the conditions. More details regarding verifying transaction data may be described above, for example, with regard to modules 206 and/or 207.

FIG. 6 is a flowchart of an example method 600 for centralized versatile transaction validation. Method 600 may be executed by a verification computing device, for example, similar to verification computing device 500 FIG. 5. Method 600 may be executed by other suitable systems and/or computing devices, for example, CVS 102 of FIG. 1. Method 600 may be implemented in the form of executable instructions stored on a machine-readable storage medium, such as storage medium 520, and/or in the form of electronic circuitry. In alternate embodiments of the present disclosure, one or more steps of method 600 may be executed substantially concurrently or in a different order than shown in FIG. 6. In alternate embodiments of the present disclosure, method 600 may include more or less steps than are shown in FIG. 6. In some embodiments, one or more of the steps of method 600 may, at certain times, be ongoing and/or may repeat.

Method 600 may start at step 602 and continue to step 604, where verification computing device 500 may maintain (e.g., via instructions 522) attributes and conditions. At step 606, verification computing device 500 may receive (e.g., via instructions 524) transaction data. At step 608, verification computing device 500 may normalize (e.g., via instructions 526) transaction the data. At step 610, verification computing device 500 may verify (e.g., via instructions 528) the transaction data, for example, by analyzing it with regard to the conditions. Method 600 may eventually continue to step 612, where method 600 may stop.

1. A system for centralized transaction verification, the system comprising:
at least one processor to:
maintain a set of tracked attributes and a set of conditions, where each condition is based on at least one of the tracked attributes;
receive transaction data packets from multiple heterogeneous transaction placement systems, each transaction data packet to relate to a particular transaction and to include any number of attributes of any type and any formatting, and each attribute with an associated attribute value;
for each received transaction data packet:
normalize each included attribute/value pair that is associated with one of the tracked attributes, and
analyze each included attribute/value pair that is not associated with one of the tracked attributes to determine whether a new attribute should be added to the set of tracked attributes and/or whether a new condition should be added to the set of conditions; and
determine, for each received transaction data packet, whether the associated transaction should be allowed to complete based on a subset of conditions from the set of conditions.

2. The system of claim 1, wherein the normalization of each attribute/value pair is to format the attribute and/or the associated value according to a formatting of the associated tracked attribute.

3. The system of claim 1, wherein, with regard to the normalization of each attribute/value pair, the attribute/value pair is associated with a particular tracked attribute based on a text string of the attribute from the pair being similar, within a degree of error, to a text string of the particular tracked attribute.

4. The system of claim 1, wherein the at least one processor is further to determine, for each received transaction data packet, the subset of conditions to be used to determine whether the associated transaction should be allowed, wherein the determination of the subset is to identify conditions from the set of conditions that are related to the attributes included in the transaction data packet.

5. The system of claim 1, wherein the conditions in the set of conditions are unstructured such that multiple conditions in the set of conditions are independent of other conditions in the set and such that multiple conditions in the set of conditions are not pre-organized according to a unified logic structure.

6. The system of claim 5, wherein the determination, for each received transaction data packet, of whether the associated transaction should be allowed is further to analyze the subset of conditions, which are unstructured, to determine how to resolve any conflicts between the conditions of the subset.

7. The system of claim 1, wherein the at least one processor is further to, for each received transaction data packet, log each included attribute/value pair that is not associated with one of the tracked attributes, wherein the determination of whether a new attribute should be added to the set of tracked attributes and/or whether a new condition should be added to the set of conditions is to analyze the logged attribute/value pairs for previously received transaction data packets.

8. The system of claim 1, wherein the at least one processor is further to:
log the received transaction data packets over multiple transactions;
analyze the received transaction data packets to determine that a pattern exists; and
create a new condition to add to the set of conditions based on the pattern.

9. A method for centralized transaction verification, the method comprising:
maintaining a set of tracked attributes and a set of conditions, each condition providing an indication of whether generally a transaction should be allowed based on at least one of the tracked attributes and an associated value;
receiving multiple transaction data packets from multiple heterogeneous transaction placement systems, a first transaction data packet of the multiple transaction data packets relating to a first transaction, the first transaction data packet including a first set of attributes;
normalizing the first transaction data packet by normalizing at least one of the attributes in the first set of attributes based on a formatting of at least one of the tracked attributes;
analyzing the attributes related to the first transaction with respect to previously received attributes related to other transactions to determine whether any of the attributes of the first transaction fit a pattern; and
verifying the first transaction by analyzing conditions from the set of conditions that are related to the attributes of the first transaction and further based on the determination of whether the attributes of the first transaction fit a pattern.

10. The method of claim 9, wherein the transaction data packets from the multiple heterogeneous transaction placement systems are each received in a data dump manner, such that the attributes in the transaction data packets need not be organized according to particular entry fields, and such that each transaction data packet may include any number and type of attributes.

11. The method of claim 9, further comprising communicating with a reference system to determine the validity of a value of at least one attribute of the first transaction data packet, wherein the verification of the first transaction is further based on the validity of the value of the at least one attribute.

12. The method of claim 9, further comprising:
logging, over time, the transaction data packets received from the multiple heterogeneous transaction placement systems; and
developing, based on machine learning, at least one pattern based on the logged transaction data,
wherein the at least one developed pattern is used for the determination of whether the attributes of the first transaction fit a pattern.

13. The method of claim 9, further comprising:
logging, over time, the transaction data packets received from the multiple heterogeneous transaction placement systems;
developing, based on machine learning at least one pattern based on the logged transaction data; and
creating a new condition to add to the set of conditions based on the at least one pattern.

14. A machine-readable storage medium encoded with instructions executable by at least one processor of a system for centralized transaction verification, the machine-readable storage medium comprising:
instructions to maintain a set of tracked attributes and a set of conditions, each condition to provide an indication of whether generally a transaction should be allowed based on at least one of the tracked attributes and an associated value;
instructions to receive transaction data packets from multiple heterogeneous transaction placement systems, each transaction data packet to relate to a particular transaction and to include any number attributes of any type and any formatting, and each with an associated attribute value;
instructions to normalize each of the transaction data packets, the normalization to modify attributes associated with the particular transaction data packet based on a formatting of at least one of the tracked attributes; and
instructions to verify each of the transaction data packets by analyzing a subset of conditions from the set of conditions where the conditions in the subset are related to the attributes associated with the particular transaction data packet.

15. The machine-readable storage medium of claim 14, wherein the conditions in the set of conditions are unstructured such that multiple conditions in the set of conditions are independent of other conditions in the set and such that multiple conditions in the set of conditions are not pre-organized according to a unified logic structure.

16. The machine-readable storage medium of claim 15, wherein the instructions to verify of each of the transaction data packets includes instructions to determine whether conditions in the subset of conditions supersede other conditions in the subset, conflict with other conditions in the subset, are more severe than other conditions in the subset, or more important than other condition in the subset.

17. The machine-readable storage medium of claim 13, wherein the instructions to verify of each of the transaction data packets includes instructions to determine, for each transaction data packet, whether the attributes in the transaction data packet fit a pattern based on previously received transaction data packets.
